(19) United States
(12) Patent Application Publication
(10) Pub. No.: US 2024/0420114 A1
(43) Pub. Date: Dec. 19, 2024

(54) VALUE BOUNDING FOR DIGITAL TOKEN ASSETS TO SIMULATE EXTERNAL REAL ASSETS WITH EXCHANGEABILITY

(71) Applicant: Shareland, Inc., Los Angeles, CA (US)

(72) Inventors: Hamet Watt, Los Angeles, CA (US); Justin Hughes, Los Angeles, CA (US); Andrey Pavlov, Vancouver (CA); Susan Wachter, Berwyn, PA (US); Martin Gagnon, Lac-Beauport (CA)

(21) Appl. No.: 18/742,588

(22) Filed: Jun. 13, 2024

Related U.S. Application Data
(60) Provisional application No. 63/508,124, filed on Jun. 14, 2023.

(51) Int. Cl. G06Q 20/36; G06Q 40/04

(52) U.S. Cl. CPC G06Q 20/36; G06Q 40/04

(57) ABSTRACT

A smart contract platform that makes use of a token oracle and smart contract native functions (mint and burn) that maintain a peg without a counterparty. The oracle is based on an externally verified value such as the price of real estate in a given geographic region. The peg is maintained naturally by a mint function that becomes preferential if the market extends above the oracle based on an oracle-locked collateral, and a burn function that returns an oracle value of collateral regardless of the market.

### CROSS-REFERENCE TO RELATED APPLICATIONS

This application claims priority to and the benefit of U.S. Provisional Application No. 63/508,124 titled “DISTRIBUTED BLOCKCHAIN PROTOCOL THAT AUTOMATICALLY ADJUSTS TO EXTERNALLY MEASURED CIRCUMSTANCES” and filed on Jun. 14, 2023. The entirety of the contents of the aforementioned application are incorporated herein by reference.

### TECHNICAL FIELD

This disclosure relates to distributed consensus networks and more particularly to cryptographic protocols relating to immutable public blockchain ledgers.

### BACKGROUND

Cryptocurrencies such as Bitcoin and Ethereum operate on distributed consensus networks that are recorded by blockchain data structures. A blockchain is an immutable, append-only public ledger. A benefit of such a data structure is that it is reliable, secure, and open. Some blockchain networks make use of programmable tokens and smart contracts that execute programs via a virtual machine. One such blockchain network is the Ethereum network.

### BRIEF DESCRIPTION OF THE DRAWINGS

FIG. 1 is a block diagram of a blockchain data structure.

FIG. 2 is a block diagram illustrating a data structure of a smart contract.

FIG. 3 is a flowchart illustrating a peg mechanism based on an externally evaluated oracle.

FIG. 4 is a flowchart illustrating the operation of a distributed oracle.

FIG. 5 is a block diagram of the custom token platform.

FIG. 6 is a block diagram showing an example of a processing device that can represent a system to run any of the methods/algorithms described above.

### DETAILED DESCRIPTION

The present disclosure is generally directed to providing digital token assets that simulate the performance or behavior of external real assets while reducing the influence of token exchange dynamics within the token environment. In particular, the present disclosure provides technical solutions addressing the technical challenges of providing digital twins or simulations that are susceptible to deviating from their target based on the use of the digital twins/simulations within the digital virtual environment.

In exemplary aspects of the present disclosure, a custom token protocol is designed to maintain a peg between the oracle value and the market price for a given token. The peg effectively bounds or confines the market price for a given token from deviating too far from the oracle value (e.g., the target that the given token is intended to simulate), which may occur due to fluctuations in either one or both of the market price and the oracle value. Specifically, the peg is to an externally validated value that itself can change. A given example of a peg value that may be evaluated externally and is variable is a property value of a given neighborhood or municipality. With a peg like the example provided, the custom token protocol empowers users to gain exposure to the price movement of residential real estate. Therefore, if a user buys a token, and the associated neighborhood appreciates in value by 50%, the user rightfully expects that token to appreciate in value by an amount as close to 50% as possible. In this way, holding the token can simulate the experience of holding the real estate/property/asset, while providing other benefits such as better exchangeability or liquidity and easier management. Market forces will push the token price upward or downward from the oracle value, so there is an expectation that there will be a price difference; however, a variety of token peg mechanics will keep that difference low. In the custom token protocol, the peg mechanism involves no counterparty. The smart contract to which the token is beholden causes the peg mechanism to occur without the need for both a buyer and a seller.

Furthermore, if that difference is consistent (i.e., there is a 3% token premium when a user obtains a token, and a 3% premium when that user sells the token), then it will effectively have no impact on the overall goal: if the premium on exit remains equal to the premium on entry, the net investment result will equal the price movement of the underlying real estate. The pegging function is a “soft” function in that the pegging function operates based on enabling smart contract user actions based on the externally evaluated data.

There is a trade-off between “hard” vs. “soft” peg mechanics and user experience. This user-friendly approach allows a minimal amount of token price drift vs. the underlying oracle/peg price, but that price difference is maintained to be as consistent as possible, thus rendering the difference to be an irrelevant factor when it comes to correlation between token performance and the performance of the underlying real estate.

The main peg mechanism employed is that the collateral requirement to mint tokens is linked to the oracle value, which creates an anchor to real-world real estate pricing. If the token price exceeds the collateral required ($110 in the above example), a miner can mint at the minimum collateral level and sell at the market price for an immediate risk-free profit. Even if the token price does not exceed the required collateral but approaches it from below, a miner has a strong incentive to issue and sell tokens because the de facto cost of doing so approaches zero. This mechanism limits the extent to which the token price can exceed the oracle value. An analogous mechanism exists if the token price is below the oracle value. In this case, no additional tokens would be issued, and existing issuers would have an incentive to buy tokens on the open market and burn them to retrieve their collateral, which at that point would be high relative to the token price. The essence of the above mechanism is to allow for small fluctuations in demand to be absorbed primarily by token price changes, while allowing larger fluctuations to be absorbed primarily by changes in token supply.

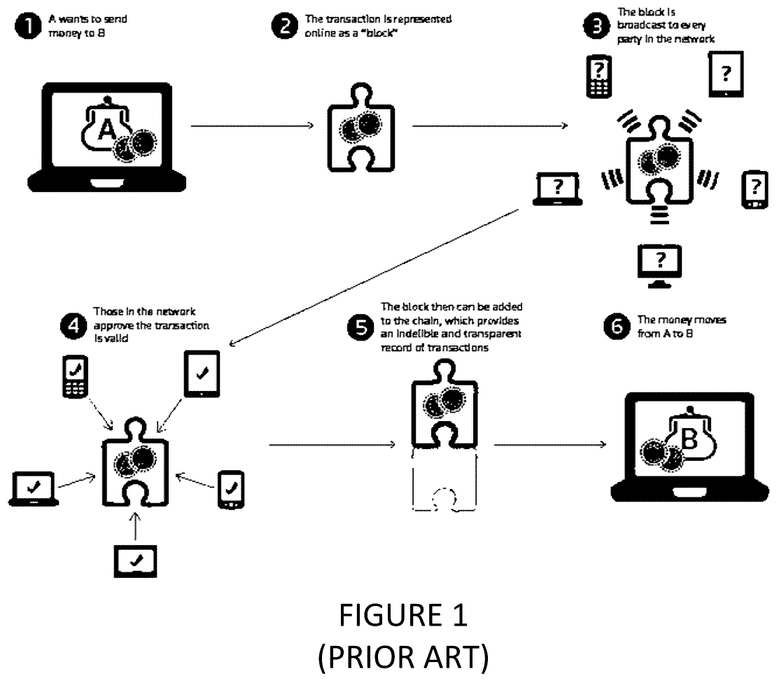

FIG. 1 is a block diagram of a blockchain data structure. Cryptocurrency networks operate on a distributed network architecture. Key to understanding cryptocurrency is the data structure upon which the network operates. For example, the Bitcoin and Ethereum networks use a data structure referred to as a blockchain.

The blockchain includes a history of all transactions that have ever occurred on the network. Each full node in the distributed network holds a full copy of the blockchain. To participate in the network at all, the blockchain history must be consistent with the history of at least a majority of other nodes. This consistency rule has an important effect of causing the blockchain to be immutable. In order to effectively attack a blockchain, one must control 51% or more of the processing power of the entire network. Where the network comprises thousands of nodes, assembling the requisite 51% is exceedingly difficult. While it is true that many nodes often group into pools to work together to solve for nonces to propagate the blockchain, the grouped nodes of the pool do not necessarily share common control. While they have agreed to pay any mined coins to a central pot that is shared among the nodes of the pool, this is a far cry from agreeing to make changes to the blockchain.

When a given node intends to generate a transaction, the transaction is propagated throughout the nodes until it reaches a node or group of nodes that can assemble that transaction and other transactions generated during a contemporaneous period of time into a block. Until a transaction appears in a block, it is not published or public. Often a transaction isn't considered confirmed until 6 additional blocks have been added.

At the time of this filing, Bitcoin blocks are limited to the size of 1 MB and are generated approximately every 10 to 15 minutes. This illustrates an important limitation of the Bitcoin network: that it processes approximately only 7 transactions per second. Conversely, Ethereum limits block size based on the amount of processing the contracts in the given block call for, and blocks are appended every 5 to 15 seconds. While cryptocurrency networks technically begin processing transactions in real time, and the existence of a block including a given transaction verifies that transaction's authenticity, until that block is published to the blockchain, the transaction is not verified.

The presence of gaps in verification time introduces the issue within the Bitcoin network at a given moment of “who has the money?” During the 10- to 15-minute span between generation of one block and the next, transactions that have been submitted may not actually process. This would occur when a user spends money they didn't have, or double spends. This is not to say the network has no verification mechanism between blocks. For example, when a given user attempts to pay another user, the system may easily query older blocks to inspect the given user's balance as of at least the most recently published block. If the given user has sufficient funds, it is moderately safe to trust the transaction.

However, if the given user is attempting to double spend all their money, only one of those transactions will publish in the next block. The other will be rejected (which transaction is rejected and which one processes is subject to a race condition and is not necessarily dependent on time of generation).

Thus far, Bitcoin has been discussed as a network for trading Bitcoins. However, Bitcoin transactions have additional utility in that they can embed additional data. As contemplated above, Bitcoin can be used to purchase and record the existence of data at a given point in time. Recording data is performed by including hashed data within an output field of a given transaction. In this manner, the proof of existence for any document or recorded data may be embedded into the immutable history of the blockchain.

Systems that utilize the Bitcoin blockchain to transfer the ownership of non-coin assets require software that is separate from and merely relies upon the immutability of the blockchain. The separate software is not necessarily secure or immutable itself. Extra-blockchain software is thus an inherent weak point in a system that relies upon the immutability of the blockchain to ensure security. Ethereum takes the ability to buy and sell non-coin assets a step further.

Ethereum smart contracts are in effect software that runs on the blockchain. That software is open source and subject to inputs that are related to the blockchain itself. Of course, one can still write code including vulnerabilities, but the platform enables greater security and results in fewer weak links in the chain.

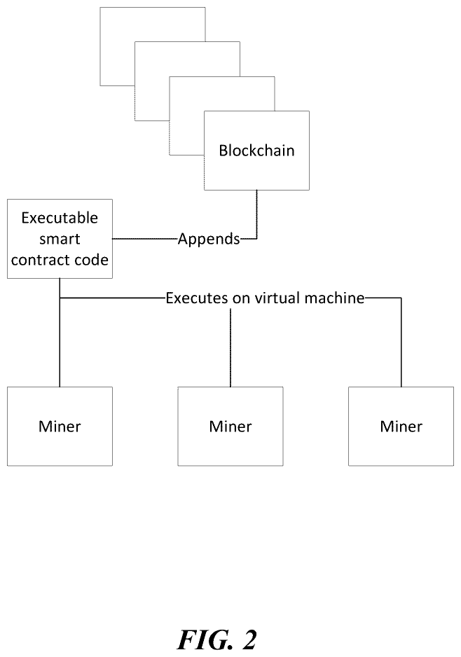

FIG. 2 is a block diagram illustrating a data structure of a smart contract. Smart contracts and decentralized applications (dApps) execute on an Ethereum virtual machine (EVM). The EVM is instantiated on available network nodes. Smart contracts and dApps are applications that execute; thus, the processing power to do so must come from hardware somewhere. Nodes must volunteer their processors to execute these operations based on the premise of being paid for the work in Ethereum coins, referred to as ether, measured in “gas.” Gas is the name for a unit of work in the EVM. The price of gas can vary, often because the price of ether varies, and is specified within the smart contract/dApp.

Every operation that can be performed by a transaction or contract on the Ethereum platform costs a certain number of gas, with operations that require more computational resources costing more gas than operations that require fewer computational resources. For example, a multiplication instruction requires 5 gas, whereas an addition instruction requires 3 gas. Conversely, more complex instructions, such as a Keccak256 cryptographic hash, requires 30 initial gas and 6 additional gas for every 256 bits of data hashed.

The purpose of gas is to pay for the processing power of the network on execution of smart contracts at a reasonably steady rate. That there is a cost at all ensures that the work/processing being performed is useful and valuable to someone. Thus, the Ethereum strategy differs from the Bitcoin transaction fee, which is dependent only on the size in kilobytes of a transaction. As a result of Ethereum's gas costs being rooted in computations, even a short segment of code can result in performance of a significant amount of processing. The use of gas further incentivizes coders to generate efficient smart contracts/algorithms; otherwise, the cost of execution may spiral out of control. Unrestricted, an exponential function may bankrupt a given user.

While operations in the EVM have a gas cost, gas has a “gas price” measured in ether. Transactions specify a given gas price in ether for each unit of gas. The fixing of price by transaction enables the market to decide the relationship between the price of ether and the cost of computing operations (as measured in gas). The total fee paid by a transaction is the gas used multiplied by the gas price.

If a given transaction offers very little in terms of a gas price, that transaction will have low priority on the network. In some cases, the network miners may place a threshold on the gas price each is willing to execute/process for. If a given transaction is below that threshold for all miners, the process will never execute. Where a transaction does not include enough ether attached (e.g., because the transaction results in so much computational work that the gas costs exceed the attached ether), the used gas is still provided to the miners. When the gas runs out, the miners will stop processing the transaction, revert any changes made, and append to the blockchain with a “failed transaction.” Failed transactions may occur because the miners do not directly evaluate smart contracts for efficiency. Miners will merely execute code with an appropriate gas price attached. Whether the code executes to completion or stalls out due to excessive computational complexity is of no matter to the miner.

Where a high gas price is attached to a transaction, the transaction will be given priority. Miners will process transactions in order of economic value. Priority on the Ethereum blockchain works similarly to priority on the Bitcoin blockchain. Where a user attaches more ether to a given transaction than necessary, the excess amount is refunded back to that user after the transaction is executed/processed. Miners only charge for the work that is performed. A useful analogy regarding gas costs and price is that the gas price is similar to an hourly wage for the miner, whereas the gas cost is like a timesheet of work performed.

One type of smart contract that exists on the Ethereum blockchain involves ERC-20 (Ethereum Request for Comment 20) tokens. ERC-20 is a technical specification for fungible utility tokens. ERC-20 defines a common list of rules for Ethereum tokens to follow within the larger Ethereum ecosystem, allowing developers to accurately predict interaction between tokens. These rules include how the tokens are transferred between addresses and how data within each token is accessed. ERC-20 provides a framework for a means to build a token on top of a base cryptocurrency. In some embodiments herein, enhancements are built on top of the ERC-20 framework, though use of the ERC-20 technical specification is not inherently necessary and is applicable to circumstances where Ethereum is used as the base cryptocurrency.

Thus far, discussion has been focused around Bitcoin and Ethereum. As applicable in this disclosure, these are base cryptocurrencies. Other base cryptocurrencies exist now and will exist in the future. This disclosure is not limited to application specifically on the Bitcoin and Ethereum blockchains.

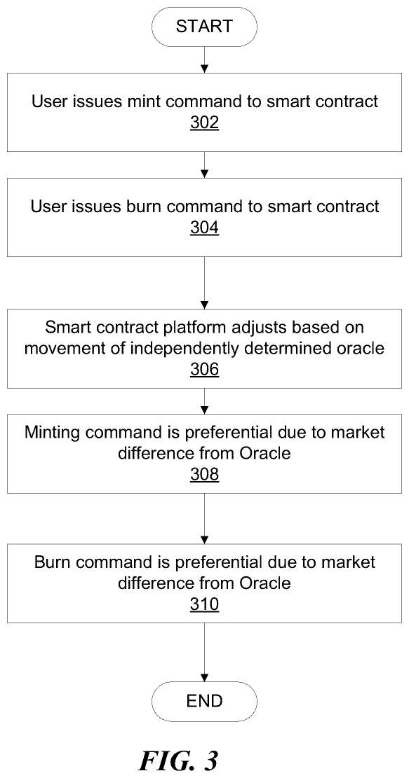

FIG. 3 is a flowchart illustrating a peg mechanism based on an externally evaluated oracle for preventing significant deviations of a token from simulating a real asset's performance/behavior. The smart contract in which the custom token operates does not make use of a counterparty, or “trades.” Users are able to burn or mint tokens based on functions available in the smart contract. Users minting or burning tokens can use any amount of external resources (e.g., dollars or cryptocurrency). In some embodiments, the peg value is based on real estate in any geography—from a specific neighborhood to the entire United States to the entire world, and every level in between.

The custom token is a protocol that allows anyone to trade synthetic land tokens that track the price of residential real estate in a given neighborhood. Each land token represents a square foot of real estate for a given neighborhood, and the pricing of each token tracks the average $/sqft of residential real estate for that neighborhood.

In step 300, a peg mechanism obtains an oracle value. The oracle value is an externally verifiable datapoint that varies over time. Step 300 is performed at regular intervals to update the existing oracle value. The oracle value pertains to a particular cryptographic token, and the disclosed platform may include a significant plurality of different digital token assets. For example, a first token associates with an oracle value of a square foot of real estate in the San Francisco Bay area of California, whereas a second token associates with an oracle value of a square foot of real estate in the city of San Francisco proper. A third token associates with an oracle value of a square foot of real estate in San Jose, California. A fourth token associates with an oracle value of a square foot of real estate in the SoMa (South of Market) neighborhood of San Francisco.

Which externally verifiable data is used as an oracle value alters the manner in which the data is obtained. With respect to real estate values, real estate sales data is public information, and all sales occurring in the relevant geographic area associated with a given token over a period of time are averaged together. The period of time is predetermined and included in the smart contract for the custom token protocol. Example periods include daily, weekly, and monthly.

In step 302, a user makes a request of automated market makers (AMMs) on public blockchains, taking long positions on various neighborhoods and subsequently realizing gains (or losses) depending on market performance. While counterparty trades are available to users, smart contract peg functions do not make use of counterparties. The action taken by the user is a “mint” action. Anyone can mint a land token by locking up collateral in the form of a digital asset (e.g., a stablecoin). The mint action is functionally akin to receiving or purchasing a token from the protocol (e.g., from a token pool with a finite supply of tokens).

Core to the custom token protocol are the neighborhood oracles. These oracles act as the source of truth for the actual $/sqft pricing of each neighborhood supported on the platform. When a user wants to mint a land token, the collateral needed is calculated against the oracle value for the given neighborhood. For any given land token, there is a minimum collateral requirement that is a multiple of the underlying price of the neighborhood's real world $/sqft price (for example, 110% for stablecoin collateral in low-volatility neighborhoods). For instance, the minting value or price simulates or approximates the real world $/sqft price by a variable approximation factor, which can be the collateral requirement. For instance, if houses in a given neighborhood are selling for an average of $100/sqft, then in order to mint a land token for that neighborhood, a user would need to put up at least $110 worth of stablecoin as collateral.

In step 304, the user executes a “burn” function. A user who has previously minted/borrowed tokens can burn (or “redeem”) up to the initially minted amount of tokens to receive their locked collateral. This may be done at a later point in time, so that the user receiving their locked collateral may be processed according to a different real world $/sqft price (e.g., an increased real world price, a decreased real world price) and/or a different market value of the tokens.

The custom token protocol is designed to maintain a peg between the oracle value and the market price for a given token. Ultimately, the goal of the custom token protocol is to empower investors to gain exposure to the price movement of residential real estate. Therefore, if a user buys/mints a token, and the associated neighborhood appreciates in value by 50%, the user rightfully expects that token to appreciate in value by an amount as close to 50% as possible. Market forces will push the token price upward or downward from the oracle value, so there is an expectation that there will be a price difference; however, a variety of token peg mechanics will keep that difference low.

The smart contract allows for a minimal amount of price drift vs. the underlying oracle value, but the smart contract maintains that price difference to be as consistent as possible, thus rendering the difference to be an irrelevant factor when it comes to correlation between token performance and the performance of the underlying real estate. That is, the smart contract maintains the underlying real world values or prices as the principal driver for token value, and provides a degree of resilience for the token value to token market forces.

In step 306, when the token has a value a threshold percentage above the oracle value, the smart contract enables free or discounted minting. For example, the minting function defined in the token specification or protocol is modified to provide free or discounted minting. If a user can mint a token for less than they can sell it for, then an arbitrage opportunity exists that will exert downward price pressure due to supply flooding the market. Specifically, the “free” minting action drops the required collateral ratio (e.g., or variable approximation factor) or introduces negative fees. The platform moves the required collateral ratio down or makes fees negative in order to trigger “free minting” at a lower price than outlined above in step 302.

Conversely, in step 308, when a token has a value a threshold percentage below the oracle value because of oracle upward price movement (i.e., real estate has gone up), the smart contract enables short liquidation. For example, short positions that were enabled by the functions defined in the token specification or protocol are closed and disabled after the functions are (temporarily) modified. Specifically, if the oracle value moves up, existing short positions (e.g., borrowed amounts of a token) are liquidated (e.g., returned to the token pool) in order to buy back tokens to be burned. This will occur because short positions will drop below their minimum required collateral level.

In step 310, when the token has a value a threshold percentage lower than the oracle value because of token downward price movement (i.e., there is a token over-supply in the token pool), the smart contract enables short closing positions, for example, by enabling borrowing requests for amounts of the token (i.e., shorting the token). For example, the functions defined in the token specification or protocol are modified or made available to enable short positions. Where the token price goes down, short positions are incentivized to buy tokens in order to burn and get their collateral back, thus adding upward pressure to the token price. Bidirectional mechanics push the oracle and the token value together, regardless of which is higher or why.

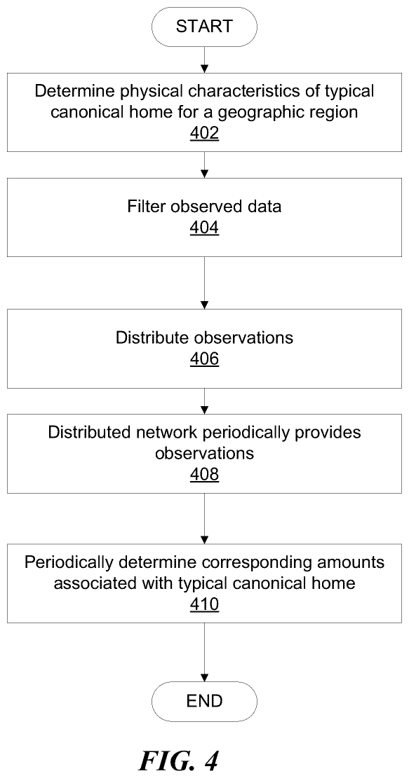

FIG. 4 is a flowchart illustrating the operation of a distributed oracle. The oracle uses external information that is computed based on characteristics of the real world. FIG. 4 uses the example of real estate, though other examples are suitable. Real estate transaction data is available on the internet through sources such as Attom Data™ though many other equivalents are available. Using that data, the oracle ultimately identifies the most common property type in each neighborhood. The oracle determines the median price per square foot of all similar recent completed transactions. This approach provides an estimate of the price per square foot of a typical home in each neighborhood, which becomes the oracle price for that neighborhood. The oracle estimate is updated daily as real estate transactions close.

The oracle is a compromise between accuracy and ease of replicability. The oracle operates on objective and consistent rules and does not seek to maximize pricing accuracy for all homes. In other words, the oracle methodology is designed to capture market evolution of a typical home over time. It is not an automated valuation system.

In step 402, the oracle determines the physical characteristics of a typical home for a particular neighborhood selected. An example of such a determination uses all transactions from the past 60 days that are similar to the typical home. If there are not enough transactions, geography is expanded to include transactions that are similar to the typical home until a predetermined minimum of number transactions is reached (e.g., 50). The oracle then computes the median price per square foot of the selected transactions. Below, Table 1 describes a number of illustrative factors that the oracle can use to identify a typical home in a particular geography.

TABLE 1

| Variable name | Description |
|---|---|
| House Size | Square feet of living area |
| Lot Size | Size of the lot |
| Beds | Number of bedrooms |
| Baths | Number of bathrooms |

In some embodiments, the oracle uses the characteristics in table 1 and no others. Notably, Table 1 is a rather limited list of ways to classify real estate. Many other physical and neighborhood characteristics influence the price of a home. For example, factors such as school quality and walkability are critical determinants of home prices. However, the oracle defines neighborhood as a relatively small geographic space, the exemplary geographic factors affect the price of all properties within a neighborhood in a similar way. Therefore, there is no need to use these variables to select the sub-set of observations that are most alike the typical house.

That said, the above does not mean neighborhood characteristics are ignored. On the contrary, changes in neighborhood characteristics over time affect transaction prices, which, in turn, determine the oracle price. In some embodiments, the oracle further relies on neighborhood boundary data. The boundary data allows the oracle to identify the transactions that fall within each neighborhood for which a cryptographic token is available.

Determining the proper physical characteristics to consider and the proper filters is the result of substantial experimentation. There are trade-offs between including more observations and including only similar observations, and the oracle uses limited characteristics to offer a good compromise between conflicting goals.

The oracle does not make use of traditional economic evaluation of real estate. The method is distinct from other valuation methods because the method focuses on the time evolution of the price of a typical or representative home, rather than the evaluation of every home. The oracle does so in a basic and simple way that captures change over time as opposed to accurate quotes.

In step 404, the observed data is filtered. As the goal is to capture the evolution of the price of a typical home over time, rather than estimate the value of a wide range of homes, the oracle applies filters to observed data. For example, observations whose house size and lot size are below 10th percentile or above 90th percentile of the sample are filtered out. Observations whose number of bedrooms and number of bathrooms are below the 1st percentile or above the 80th percentile are filtered out. Once filtered, the oracle determines the median characteristics of the remaining homes in each neighborhood. A property with the median characteristics defines the typical or representative home for each neighborhood. This representative property may be hypothetical or virtual, being the median of multiple dimensions of attributes or characteristics.

To estimate the median price, the oracle includes completed sales from a preceding period (e.g., 30, 60 days) includes observations whose size, lot size, number of bedrooms, and number of bathrooms are within 75% of the same characteristics for the typical home.

In step 406, the oracle is distributed across a blockchain network. The values in step 402/404 are sourced for typical homes in each neighborhood from community providers. The providers are rewarded for the accuracy of their estimation. Distribution eliminates a potential single point of failure for the system that provides the peg the land tokens are associated with. Distribution is performed first by identifying homes that are currently listed for sale and that meet the filters described in step 404 above. In step 408, periodically (e.g., daily) each distributed oracle provider estimates a sale price for those homes, assuming the home sells on that day. If and when a home sells, the difference between the predicted price for the sale date and the actual sale price is recorded. Oracle providers are rewarded based on the accuracy of their price prediction. In this manner, the predictive function of the oracle providers can be trained and improved.

In step 410, the platform periodically determines the median price prediction for each home and then the median across all homes in the sample. With a large number of participants, no participant has the ability to influence the median price. Oracle participants are incentivized to provide accurate predictions. Distribution estimates the current market value of each home in the sample in a decentralized and robust manner.

In some embodiments, once the oracle defines the physical characteristics and location of a typical home in a given geography, the oracle does not change those characteristics even if the composition of sales or homes changes over time. The consistency ensures that changes in the oracle values reflect changes in the market prices in a neighborhood, rather than changes in the characteristics of the typical home.

Below is an example computation of an oracle value for Beverly Hills, California. Table 2 below describes home variables for Beverly Hills.

TABLE 2

| Variable | | Value for |
|---|---|---|
| name | Description | Beverly Hills |
| Size | Square feet of living area | 3205 |
| Lot Size | Size of the lot | 7653 |
| Beds | Number of bedrooms | 4 |
| Baths | Number of bathrooms | 4 |

The estimated value and price per square foot for this typical home on a day contemporaneous with filing of the instant application is $1197.

Table 3 provides a sample list of real estate transactions that occurred in prior to that date from which the $1197 figure is derived and meet the filters described above. The median price per square foot of the 8 transactions reported in Table 3 is $1236. As stated above, the median of full sample is $1197, which constitutes the oracle price but differs from the actual values.

TABLE 3

| Date | Sq. Ft. | Lot Size | Beds | Baths | Sold Price | PSF | Date | Sq. Ft. |
|---|---|---|---|---|---|---|---|---|
| 2023 Feb. 26 | 1742 | 9581 | 2 | 2 | 1,907,000 | 1,095 | 2023 Feb. 26 | 1742 |
| 2023 Feb. 27 | 2622 | 11233 | 3 | 3 | 3,200,000 | 1,220 | 2023 Feb. 27 | 2622 |
| 2023 Feb. 27 | 999 | 4991 | 3 | 1 | 1,310,000 | 1,311 | 2023 Feb. 27 | 999 |
| 2023 Feb. 28 | 3608 | 8101 | 5 | 6 | 4,400,000 | 1,220 | 2023 Feb. 28 | 3608 |
| 2023 Mar. 1 | 4373 | 7633 | 5 | 7 | 5,475,000 | 1,252 | 2023 Mar. 1 | 4373 |
| 2023 Mar. 1 | 3488 | 6991 | 5 | 4 | 4,849,000 | 1,390 | 2023 Mar. 1 | 3488 |

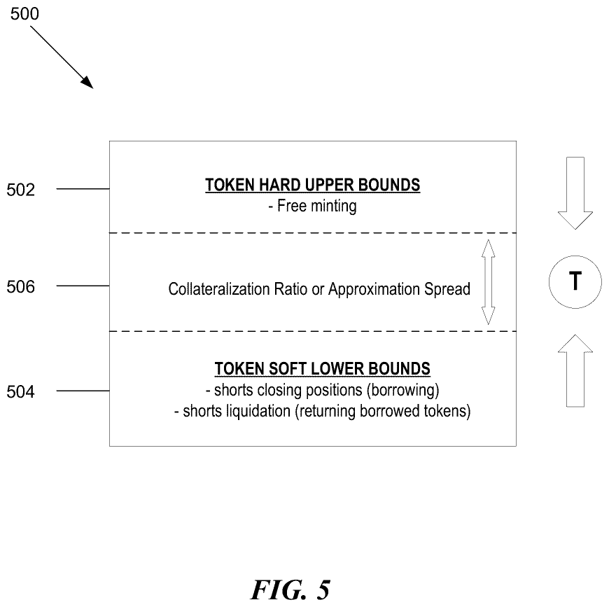

FIG. 5 is a block diagram of the custom token platform. The block diagram includes three regions: a “free mint” region 502, a liquidation region 504, and a market region 506. The bounds of the regions are set by the oracle. If the market value of the token extends into either the free mint region 502 or the liquidation region 504, the platform's native functions cause the market value to trend toward the market region 506 again.

In the free mint region 502, the collateral cost of minting is lower than the market value. In the liquidation region 504, the collateral that can be obtained by burning tokens has more value than the token. Both functions operate without a counterparty and are native functions of the smart contract.

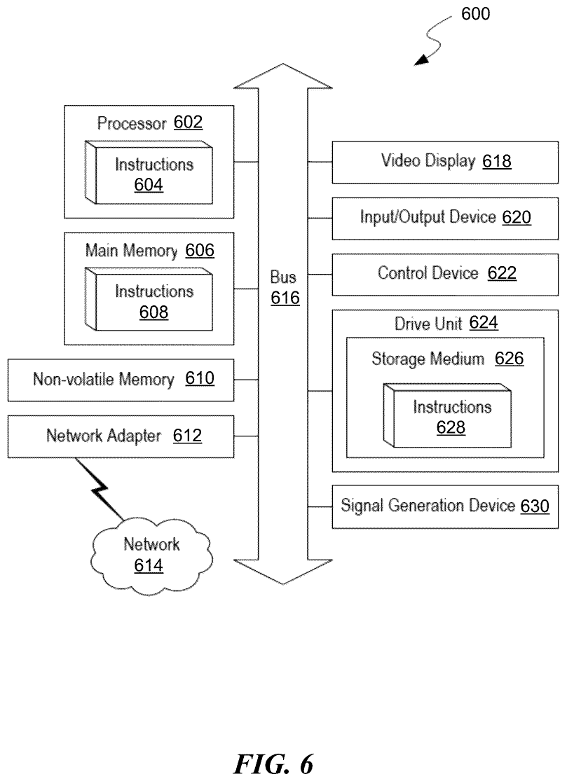

FIG. 6 is a block diagram showing an example of a processing device 600 that can represent a system to run any of the methods/algorithms described above. A system may include two or more processing devices such as represented in FIG. 6, which may be coupled to each other via a network or multiple networks. A network can be referred to as a communication network.

In the illustrated embodiment, the processing device 600 includes one or more processors 610, memory 611, a communication device 612, and one or more input/output (I/O) devices 613, all coupled to each other through an interconnect 614. The interconnect 614 may be or include one or more conductive traces, buses, point-to-point connections, controllers, scanners, adapters, and/or other conventional connection devices. Each processor 610 may be or include, for example, one or more general-purpose programmable microprocessors or microprocessor cores, microcontrollers, application-specific integrated circuits (ASICs), field-programmable gate arrays, or the like, or a combination of such devices. The processor(s) 610 control the overall operation of the processing device 600. Memory 611 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 611 may store data and instructions that configure the processor(s) 610 to execute operations in accordance with the techniques described above. The communication device 612 may be or include, for example, an Ethernet adapter, cable modem, Wi-Fi adapter, cellular transceiver, Bluetooth transceiver, or the like, or a combination thereof. Depending on the specific nature and purpose of the processing device 600, the I/O devices 613 can include devices such as a display (which may be a touch screen display), audio speaker, keyboard, mouse or another pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more ASICs, programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., ROM, RAM, magnetic disk storage media, optical storage media, or flash memory devices), etc.

Physical and functional components (e.g., devices, engines, modules, data repositories, etc.) associated with the processing device 600 can be implemented as circuitry, firmware, software, other executable instructions, or any combination thereof. For example, the functional components can be implemented in the form of special-purpose circuitry, one or more appropriately programmed processors, a single board chip, an FPGA, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip (e.g., software, software libraries, application program interfaces, etc.). The tangible storage memory can be computer-readable data storage. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

The processing device 600 may be described as a “node.” A “node” or “network node” may refer to a connection point in a communication network. A network node can be a physical electronic device that is capable of creating, receiving, or transmitting data. In some embodiments, a network node may be a computing device within a record-keeping network (e.g., a blockchain network). A network node may be able to create a data package (e.g., a data payload), transfer a data package, receive a data package, validate a data package, access a central record, and/or perform any other suitable functions. Different types of network nodes may be able to perform different sets of functions within a recording network. In some embodiments, a network node may be associated with and/or operated by a resource provider such as an online service provider, a content provider, a certificate authority, a financial institution (e.g., a bank), a merchant, a transaction processing network, or any other suitable entity.

1. A method for simulating performance of external real assets with digital token assets, the method comprising:
receiving, by a simulation protocol implemented on a decentralized cryptographic ledger that defines a set of token functions for the digital token assets, an exchange request for either one of: (i) transmitting an amount of a particular digital token from a token pool to a ledger participant according to the simulation protocol, or (ii) receiving the amount of the particular digital token from the ledger participant into the token pool according to the simulation protocol, wherein each of the digital token assets, including the particular digital token, is associated with a location-wise group of external real assets;
measuring, by the simulation protocol, a representative unit value of the location-wise group of external real assets that is associated with the particular digital token based on generating a representative asset for the location-wise group, the representative asset having multiple dimensions of attributes each derived from corresponding attributes of the location-wise group;
determining a ledger value for the particular digital token that simulates the representative unit value by a variable approximation factor;
processing the exchange request on the decentralized cryptographic ledger using the ledger value for the particular digital token; and
in response to a new ledger value resulting from the token pool including a new proportion of the particular digital token subsequent to the exchange request being processed, modifying the set of token functions defined by the simulation protocol such that performance of the modified set of token functions results in a difference between the new ledger value and the representative unit value being minimized.

2. The method of claim 1, wherein the simulation protocol defines the variable approximation factor, and wherein modifying the set of token functions defined by the simulation protocol comprises modifying the variable approximation factor.

3. The method of claim 1, wherein the set of token functions includes (i) a mint function according to which the exchange request configures the transmitting of the amount of the particular digital token from the token pool to the ledger participant, and (ii) a burn function according to which the exchange request configures the receiving of the amount of the particular digital token from the ledger participant into the token pool.

4. The method of claim 1, wherein modifying the set of token functions defined by the simulation protocol comprises:
determining that the new ledger value is less than the representative unit value as a result of the new proportion of the particular digital token in the token pool being higher than previous proportions; and
enabling borrowing requests for amounts of the particular digital token to cause the new ledger value for the particular digital token to increase towards the representative unit value.

5. The method of claim 1, wherein modifying the set of token functions defined by the simulation protocol comprises:
determining that the new ledger value is less than the representative unit value as a result of the representative unit value being higher than prior representative unit values; and
returning one or more borrowed amounts of the particular digital token to the token pool to cause the new ledger value to increase towards the representative unit value.

6. The method of claim 1, wherein modifying the set of token functions defined by the simulation protocol comprises:
determining that the new ledger value is greater than the representative unit value; and
reducing the variable approximation factor for at least a mint function included in the set of token functions to cause the new ledger value to decrease towards the representative unit value.

7. The method of claim 1, wherein the representative unit value is predicted for the representative asset according to real-world transactions executed for the location-wise group of external real assets within a preceding time period.

8. The method of claim 1, wherein the simulation protocol is distributed across a blockchain network on which the decentralized cryptographic ledger is provided, wherein each of a plurality of distributed instances of the simulation protocol is configured to estimate the representative unit value.

9. A distributed platform for a decentralized cryptographic ledger, the distributed platform comprising:
at least one processor; and
at least one memory storing instructions that, when executed by the at least one processor, cause the distributed platform to implement a simulation protocol with operations comprising:
defining a set of token functions interfacing with the decentralized cryptographic ledger for a set of digital token assets;
receiving an exchange request for either one of: (i) transmitting an amount of a particular digital token of the set of digital token assets from a token pool to a ledger participant according to the simulation protocol, or (ii) receiving the amount of the particular digital token from the ledger participant into the token pool according to the simulation protocol, wherein the particular digital token is associated with a location-wise group of external real assets;
measuring a representative unit value of the location-wise group of external real assets based on generating a representative asset for the location-wise group, the representative asset having multiple dimensions of attributes each derived from corresponding attributes of the location-wise group;
determining a ledger value for the particular digital token that simulates the representative unit value by a variable approximation factor;
processing the exchange request on a decentralized cryptographic ledger using the ledger value for the particular digital token; and
in response to a new ledger value resulting from the token pool including a new proportion of the particular digital token subsequent to the exchange request being processed, modifying the set of token functions defined by the simulation protocol such that performance of the modified set of token functions results in a difference between the new ledger value and the representative unit value being minimized.

10. The distributed platform of claim 9, wherein the set of token set of token functions includes (i) a mint function according to which the exchange request configures the transmitting of the amount of the particular digital token from the token pool to the ledger participant, and (ii) a burn function according to which the exchange request configures the receiving of the amount of the particular digital token from the ledger participant into the token pool.

11. The distributed platform of claim 9, wherein modifying the set of token functions defined by the simulation protocol comprises:
determining that the new ledger value is less than the representative unit value as a result of the new proportion of the particular digital token remaining in the token pool being higher than previous proportions; and
enabling borrowing requests for amounts of the particular digital token to cause the new ledger value for the particular digital token to increase towards the representative unit value.

12. The distributed platform of claim 9, wherein modifying the set of token functions defined by the simulation protocol comprises:
determining that the new ledger value is less than the representative unit value as a result of the representative unit value being higher than prior representative unit values; and
returning one or more borrowed amounts of the particular digital token to the token pool to cause the new ledger value to increase towards the representative unit value.

13. The distributed platform of claim 9, wherein modifying the set of token functions defined by the simulation protocol comprises:
determining that the new ledger value is greater than the representative unit value; and
reducing the variable approximation factor for at least a mint function included in the set of token functions to cause the new ledger value to decrease towards the representative unit value.

14. The distributed platform of claim 9, wherein the representative unit value is predicted for the representative asset according to real-world transactions executed for the location-wise group of external real assets within a preceding time period.

15. The distributed platform of claim 9, wherein the simulation protocol is distributed across a blockchain network on which the decentralized cryptographic ledger is provided, wherein each of a plurality of distributed instances of the simulation protocol is configured to estimate the representative unit value.

16. The distributed platform of claim 9, wherein the multiple dimensions of attributes for the representative asset are medians of the corresponding attributes of the location-wise group.

17. A non-transitory computer-readable storage medium having instructions that, when executed by at least one processor, cause the at least one processor to implement a simulation protocol for a decentralized cryptographic ledger, the simulation protocol implementing a method comprising:
defining a set of token functions performed on the decentralized cryptographic ledger for a set of digital token assets;
receiving an exchange request for either one of: (i) transmitting an amount of a particular digital token of the set of digital token assets from a token pool to a ledger participant according to the simulation protocol, or (ii) receiving the amount of the particular digital token from the ledger participant into the token pool according to the simulation protocol, wherein the particular digital token is associated with a location-wise group of external real assets;
measuring a representative unit value of the location-wise group of external real assets based on generating a representative asset for the location-wise group, the representative asset having multiple dimensions of attributes each derived from corresponding attributes of the location-wise group;
determining a ledger value for the particular digital token that simulates the representative unit value by a variable approximation factor;
processing the exchange request on a decentralized cryptographic ledger using the ledger value for the particular digital token; and
in response to a difference between a new ledger value and the representative unit value exceeding a threshold subsequent to the exchange request being processed, modifying the set of token functions defined by the simulation protocol such that performance of the modified set of token functions results in the difference being minimized.

18. The non-transitory computer-readable storage medium of claim 17, wherein the set of token set of token functions includes (i) a mint function according to which the exchange request configures the transmitting of the amount of the particular digital token from the token pool to the ledger participant, and (ii) a burn function according to which the exchange request configures the receiving of the amount of the particular digital token from the ledger participant into the token pool.

19. The non-transitory computer-readable storage medium of claim 15, wherein the representative unit value is predicted for the representative asset according to real-world transactions executed for the location-wise group of external real assets within a preceding time period.

20. The non-transitory computer-readable storage medium of claim 15, wherein the multiple dimensions of attributes for the representative asset are medians of the corresponding attributes of the location-wise group.
